(19) United States
(12) Patent Application Publication
(10) Pub. No.: US 2023/0043403 A1
(43) Pub. Date: Feb. 9, 2023

(54) INJECTION MOLD AND METHOD OF FORMING AN EYEBALL FOR A LURE HAVING A PUPIL SURROUNDED BY AN IRIS

(71) Applicant: Angling AI, Horton, MI (US)

(72) Inventor: Josh E. Clark, Horton, MI (US)

(73) Assignee: Angling AI, Horton, MI (US)

(21) Appl. No.: 17/705,229

(22) Filed: Mar. 25, 2022

Related U.S. Application Data
(60) Provisional application No. 63/165,863, filed on Mar. 25, 2021.

(51) Int. Cl. B29C 45/26; B29C 45/16

(52) U.S. Cl. CPC B29C 45/26; B29C 45/1635; B29K 2101/12

(57) ABSTRACT

An injection mold is configured to form an eyeball for a fishing lure. The injection mold includes a first mold plate, a first stem plate, a second stem plate, and a second mold plate. The first mold plate defines a first injection port. The first and second stem plates and the second stem plate each define a plurality of stem cavities. The second mold plate includes first and second sides and a second injection port extending between the first side and the second side. The second side defines an iris cavity in fluid communication with the second injection port. The injection mold is configured to be assembled in a first configuration, to receive a first flowable material to form a pupil stem of an eyeball, and a second configuration, to receive a second flowable material to form an iris of the eyeball.

### CLAIM OF PRIORITY AND CROSS-REFERENCE TO RELATED APPLICATIONS

This application claims the benefit of priority from U.S. Provisional Pat. Application No. 63165863, filed on Mar. 25, 2021, which is incorporated by reference in its entirety.

### TECHNICAL FIELD

The present disclosure is related to an injection mold and method of forming an eyeball for a fishing lure having a pupil surrounded by an iris.

### BACKGROUND

Fishing lures, such as plastic worms, have been produced using injection molding. These lures are manufactured by injecting thermoplastic material into a mold defining the shape of the worm, and then allowing the material to cure.

### SUMMARY

One general aspect includes an injection mold configured to form an eyeball for a fishing lure. The injection mold may include a first mold plate, a first stem plate, a second stem plate, and a second mold plate. The first mold plate defines a first injection port. The first stem plate and the second stem plate each define a plurality of stem cavities. The second mold plate includes: a first side and a second side, opposite the first side; and a second injection port extending between the first side and the second side. The second side defines an iris cavity in fluid communication with the second injection port. The injection mold is configured to be assembled in a first configuration, such that the first stem plate is sandwiched between the first mold plate and the second stem plate and the second stem plate is sandwiched between the first stem plate and the second mold plate. The injection mold is configured to be assembled in a second configuration, such that the first stem plate is sandwiched between the first mold plate and the second mold plate; where the stem cavity of first stem plate is aligned with the stem cavity of the second stem plate to define a stem channel in fluid communication with the first injection port when the injection mold is assembled in the first configuration. As such, the stem channel is configured to receive a first flowable material from the first injection port to form a pupil stem of an eyeball. The stem cavity of the first stem plate is in fluid communication with the iris cavity and the second injection port when the injection mold is assembled in the second configuration. The iris cavity is configured to receive a second flowable material from the second injection port to form an iris of the eyeball.

Another general aspect includes a method of forming a plurality of eyeballs using an injection mold. The method may include arranging the injection mold in a first configuration, such that a first stem plate and a second stem plate are sandwiched between a first mold plate and a second mold plate. A first flowable material is injected into the injection mold through a first injection port defined in the first mold plate to form a retina for each of the plurality of eyeballs. The second mold plate is removed the injection mold. Next, the second stem plate is removed from the first stem plate, such that a portion of each of the plurality of retinas is exposed to extend from the first stem plate. The injection mold is then arranged in a second configuration, such that a second side of the second mold plate is in facing relationship to the first stem plate, and the portion of each of the plurality of retinas extends into a respective iris cavity defined in the second surface of the second mold plate. A second flowable material is injected into the injection mold through a second injection port defined in the second mold plate to form an iris that surrounds the portion of each of the plurality of retinas extending into the respective iris cavity.

The above summary does not represent every embodiment or every aspect of this disclosure. Rather, the foregoing summary merely provides an exemplification of some of the novel concepts set forth herein. The above features and advantages, and other features and attendant advantages of this disclosure, will be readily apparent from the following description of illustrated examples and representative modes for carrying out the present disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

Various features of the present disclosure will become more fully apparent from the following description and appended claims, taken in conjunction with the accompanying drawings. Understanding that these drawings depict only typical embodiments of the disclosure and are, therefore, not to be considered limiting of its scope, the embodiments of the disclosure will be described and explained with additional specificity and detail through the use of the accompanying drawings. Advantages of the present disclosure will be readily appreciated as the same becomes better understood by reference to the following detailed description when considered in connection with the accompanying drawings wherein:

FIG. 1 is a diagrammatic top view of an injection mold in a first configuration for forming eyeballs for use with lure.

FIG. 2 is a diagrammatic bottom view of the injection mold in a first configuration.

FIG. 3 is a diagrammatic view of an eyeball formed from the injection mold.

FIG. 4 is a diagrammatic view of a portion of a third injection mold with two lures, each including an eyeball formed from the injection mold and a bloodline formed from a second injection mold.

FIG. 5 is a diagrammatic partially transparent perspective bottom view of the injection mold in the first configuration

FIG. 6 is a diagrammatic top plan view of the injection mold of FIG. 5.

FIG. 7 is a diagrammatic side view of the injection mold of FIG. 5.

FIG. 8 is a fragmentary sectional side view of the injection mold of FIG. 6, taken along line 8-8.

FIG. 9 is an enlarged view of the encircled area of FIG. 8;

FIG. 10 is a diagrammatic partially transparent perspective top view of the injection mold in the second configuration.

FIG. 11 is a diagrammatic bottom plan view of the injection mold of FIG. 10.

FIG. 12 is a diagrammatic side view of the injection mold of FIG. 10.

FIG. 13 is a fragmentary sectional side view of the injection mold of FIG. 7, taken along line 13-13.

FIG. 14 is an enlarged view of the encircled area of FIG. 13.

FIG. 15 is a diagrammatic top view of a first mold plate of the injection mold, defining a plurality of pupil channels in fluid communication with a first injection port.

FIG. 16 is a diagrammatic top view of the injection mold arranged in the first configuration, with a second mold plate facing up.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, down, upper, lower, upward and downward may be used with respect to the drawings. These and similar directional terms are not to be construed to limit the scope of the disclosure in any manner. Additionally, the disclosure, as illustrated and described herein, may be practiced in the absence of any element that is not specifically disclosed herein.

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, down, upper, lower, upward and downward may be used with respect to the drawings. These and similar directional terms are not to be construed to limit the scope of the disclosure in any manner. Additionally, the disclosure, as illustrated and described herein, may be practiced in the absence of any element that is not specifically disclosed herein.

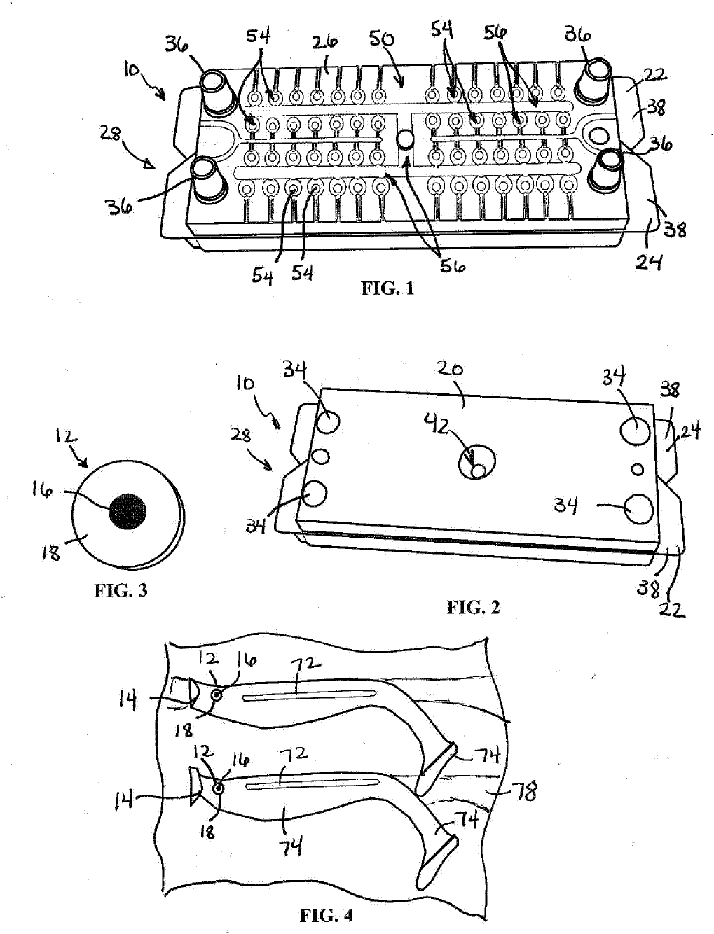

Referring to the drawings, wherein like reference numbers refer to like components throughout the several Figures, an injection mold 10 for forming an eyeball 12 for a lure 14 is shown schematically at 10 in FIG. 1. The lure 14 may be formed from soft plastic to be used as a fishing lure 14. Soft plastic lures 14 are flexible rubbery baits that imitate a variety of aquatic critters. These may include, but should not be limited to, minnows, lizards, frogs, and the like.

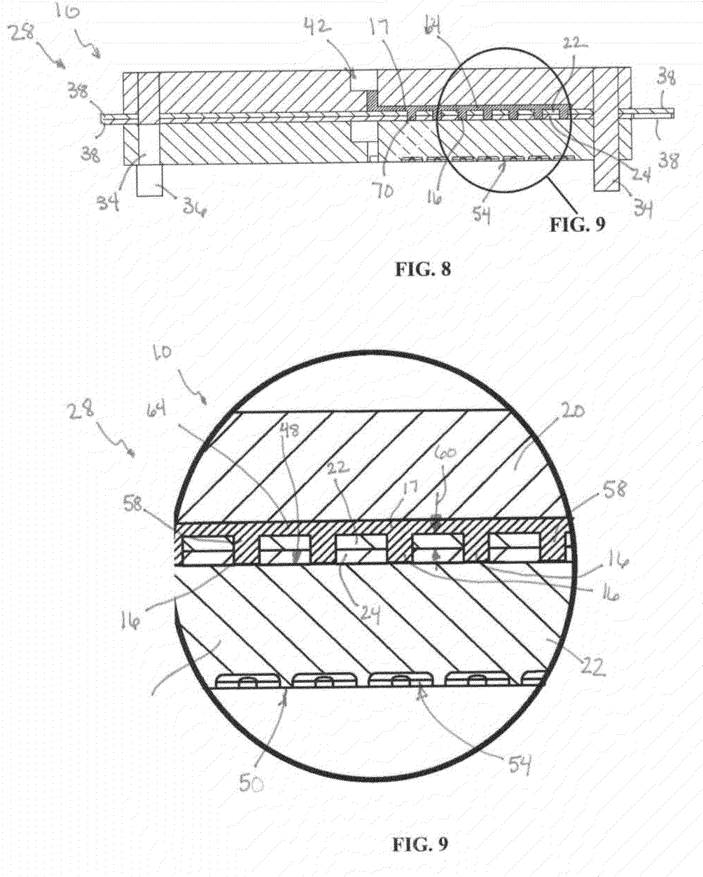

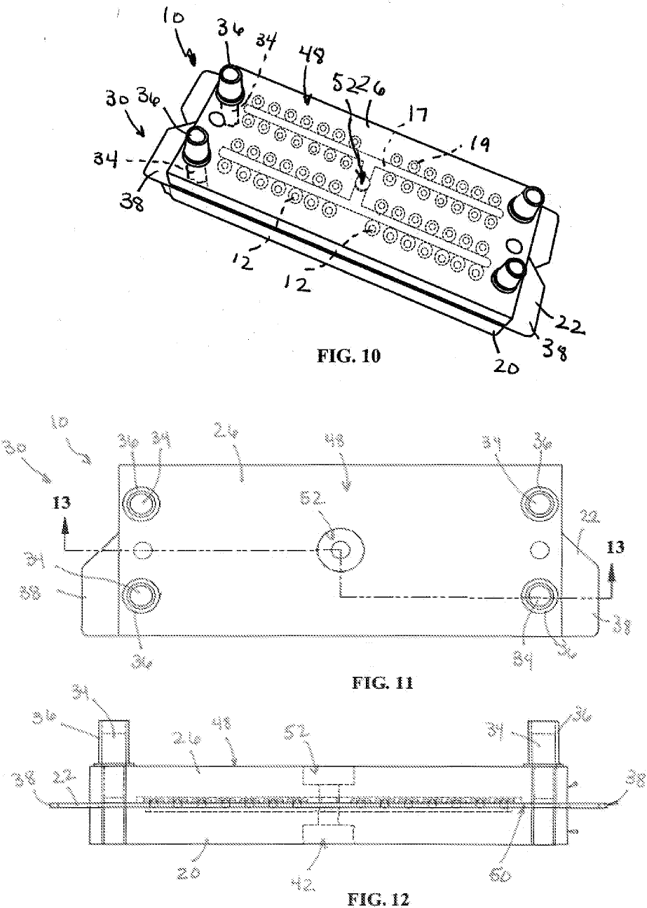

As will be explained in more detail below, the injection mold 10 is configured to mold eyeballs 12 having the appearance of a pupil 16 with a circular shape that is surrounded by, and centered within, an iris 18 (see FIGS. 3 and 4). The injection mold 10 is configured to form eyeballs 12 from two different flowable materials, i.e., a first flowable material 17 and a second flowable material 19. Therefore, any desired color are selected for forming the pupil 16 and the iris 18. The colors may be different from one another, in order to provide a desired contrast. In another nonlimiting example, the color of the iris 18 and the color of the pupil 16 are selected to be the same color.

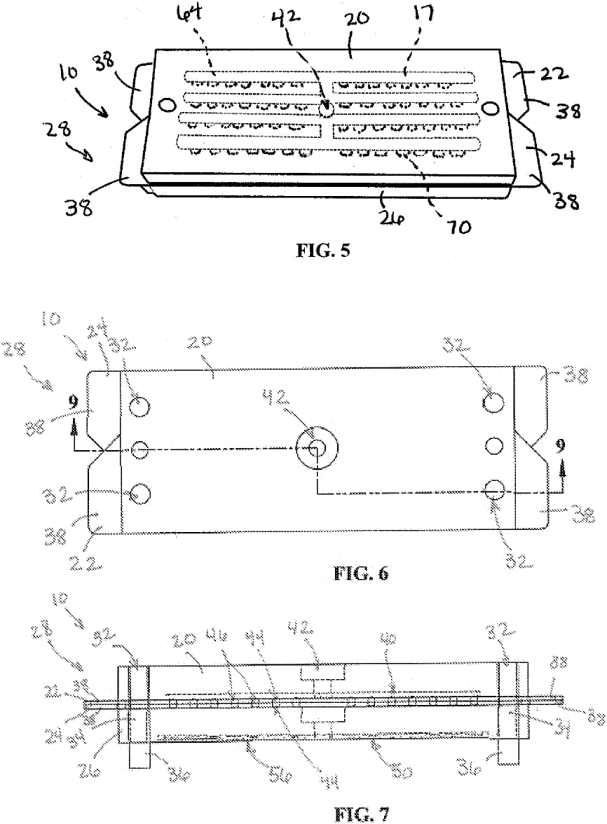

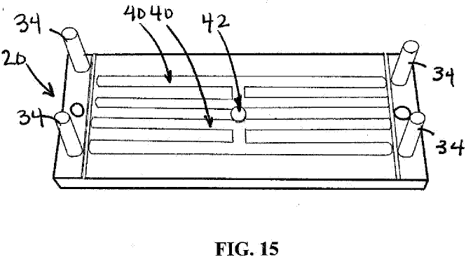

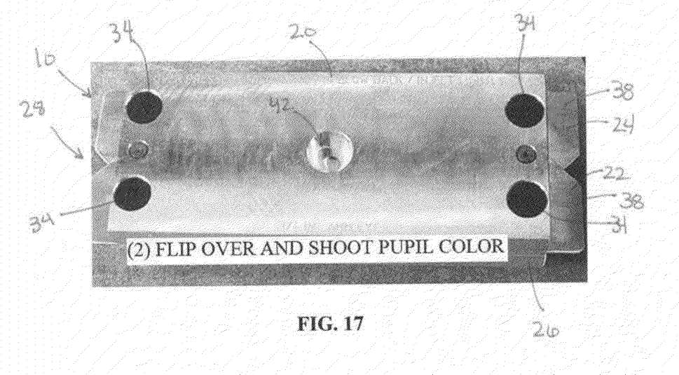

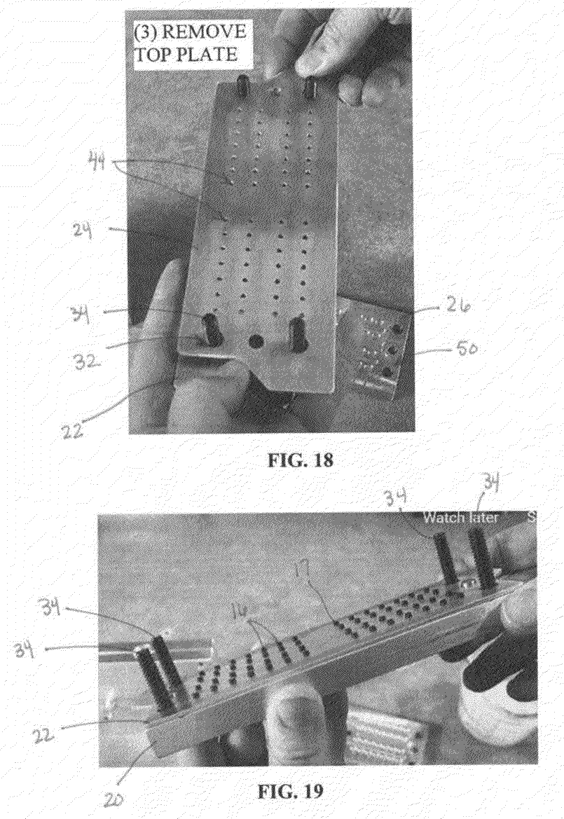

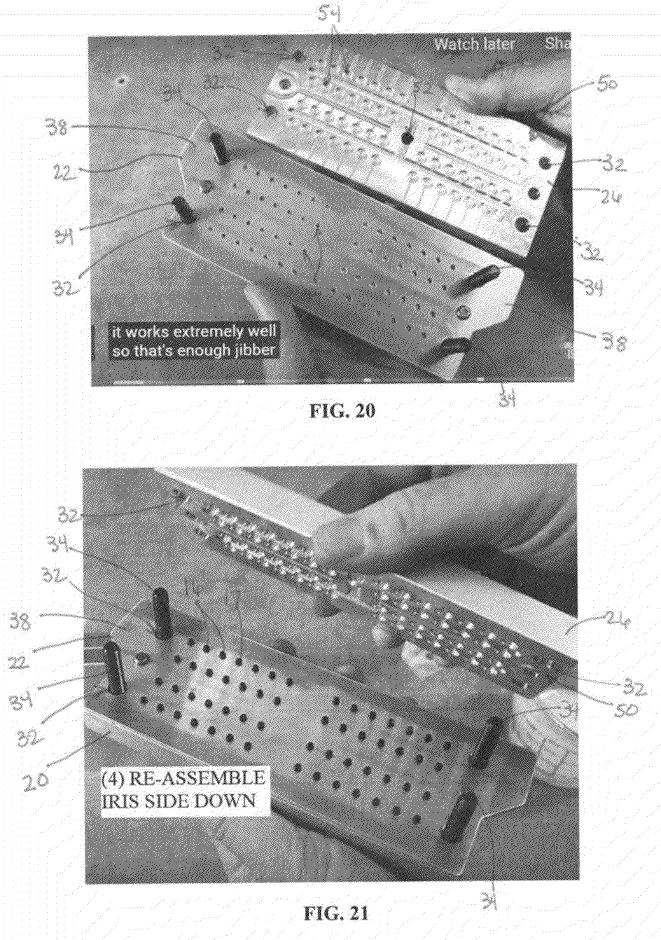

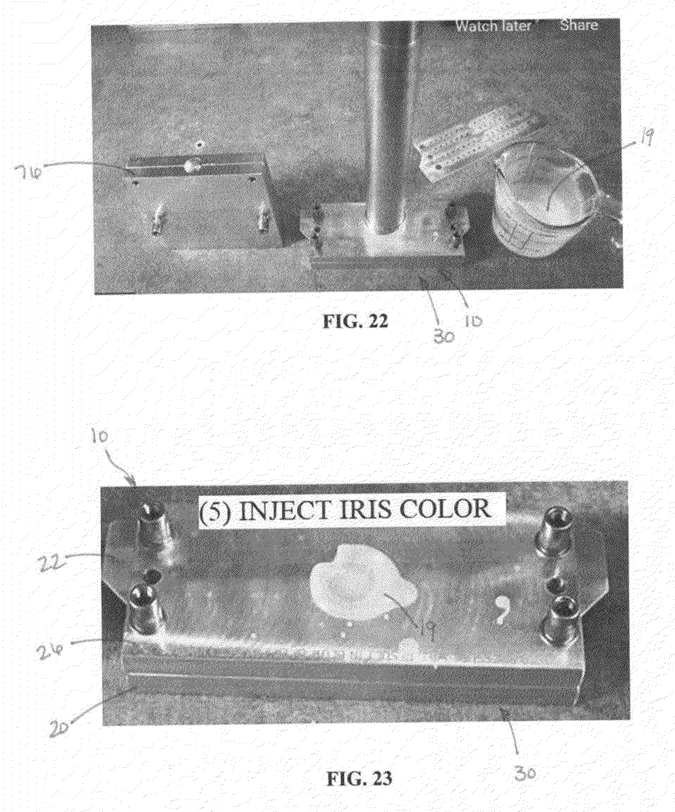

Referring to FIGS. 1 and 2, the injection mold 10 includes a first mold plate 20, a first stem plate 22, a second stem plate 24, and a second mold plate 26. The injection mold 10 is reconfigurable between a first configuration 28 (see FIGS. 1-2, 5-9, and 16) and a second configuration 30 (see FIGS. 10-14 ). When the injection mold 10 is arranged in the first configuration 28, the first mold plate 20 aligns with the second mold plate 26, with the first stem plate 22 and the second stem plate 24 sandwiched therebetween. More specifically, in the first configuration 28, the first stem plate 22 is sandwiched between the first mold plate 20 and the second stem plate 24, and the second stem plate 24 is sandwiched between the first stem plate 22 and the second mold plate 26. When the injection mold 10 is arranged in the second configuration 30, the second stem plate 24 is removed, such that the first stem plate 22 is sandwiched between the first mold plate 20 and the second mold plate 26.

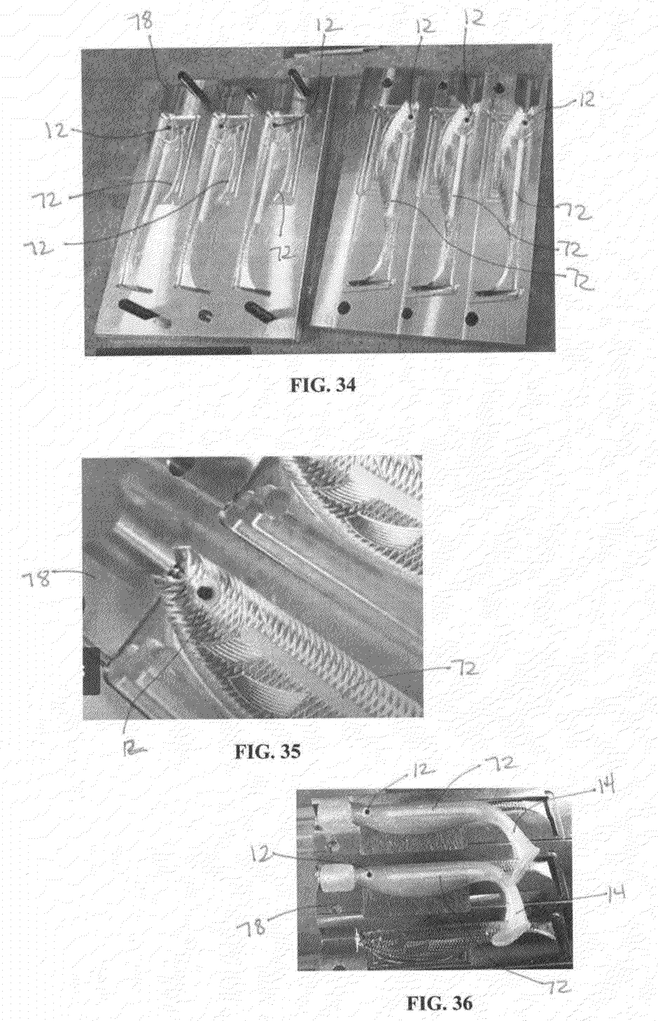

The first mold plate 20, the first stem plate 22, the second stem plate 24, and the second mold plate 26 are configured to be secured or otherwise clamped relative to one another when the injection mold 10 is in the first configuration 28. Likewise, the first mold plate 20, the first stem plate 22, and the second mold plate 26 are configured to be secured or otherwise clamped relative to one another when the injection mold 10 is in the second configuration 30. In one nonlimiting embodiment, the first mold plate 20, the first stem plate 22, the second stem plate 24, and the second mold plate 26 each define a plurality of thru-holes 32 that are configured to be in axial alignment when the injection mold 10 is in each of the first configuration 28 and the second configuration 30. In this embodiment, a threaded fastener 34 or stud extends through each of the aligned thru-holes 32, and a nut 36 is tightened to clamp the plates together. Additionally, each of the first stem plate 22 and the second stem plate 24 may include at least one tab 38 extending beyond the respective first mold plate 20 and the second mold plate 26. These tabs 38 provide leverage for the respective first stem plate 22 and the second stem plate 24 for removal relative to the other plates, as will be explained in more detail below. As illustrated in FIG. 16, the tabs 38 of the first stem plate 22 are offset from the tabs 38 of the second stem plate 24 to allow removal of the second stem plate 24 from the first stem plate 22.

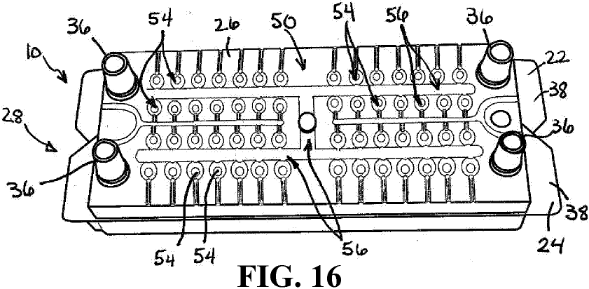

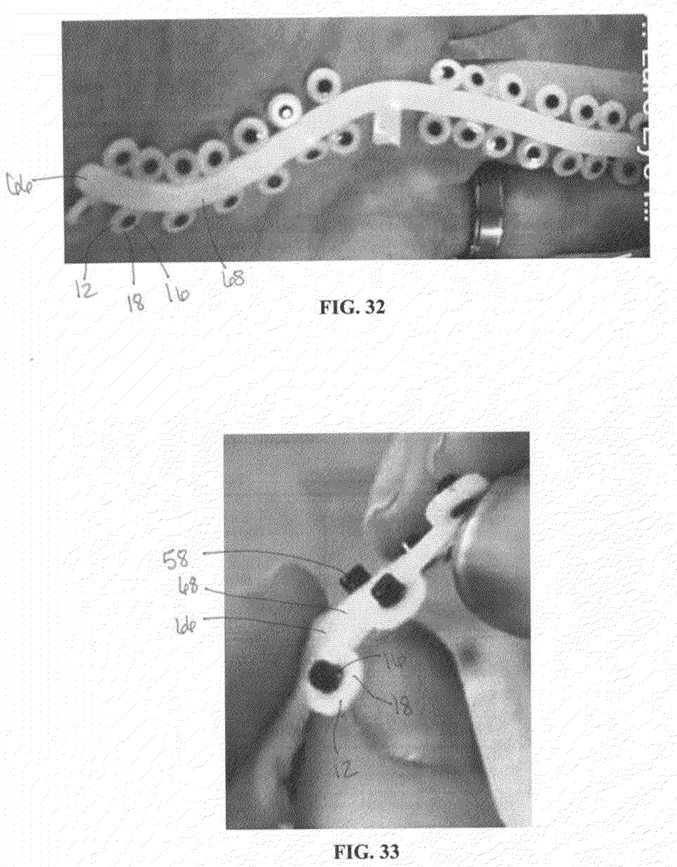

With reference to FIGS. 7, 12, 15, and 16, the first mold plate 20 defines at least one pupil channel 40 and a first injection port 42. The first injection port 42 extends through the first mold plate 20, and is in fluid communication with the at least one pupil channel 40. Referring specifically to FIG. 15, in one nonlimiting example, the first mold plate 20 defines a plurality of pupil channels 40 in fluid communication with the first injection port 42.

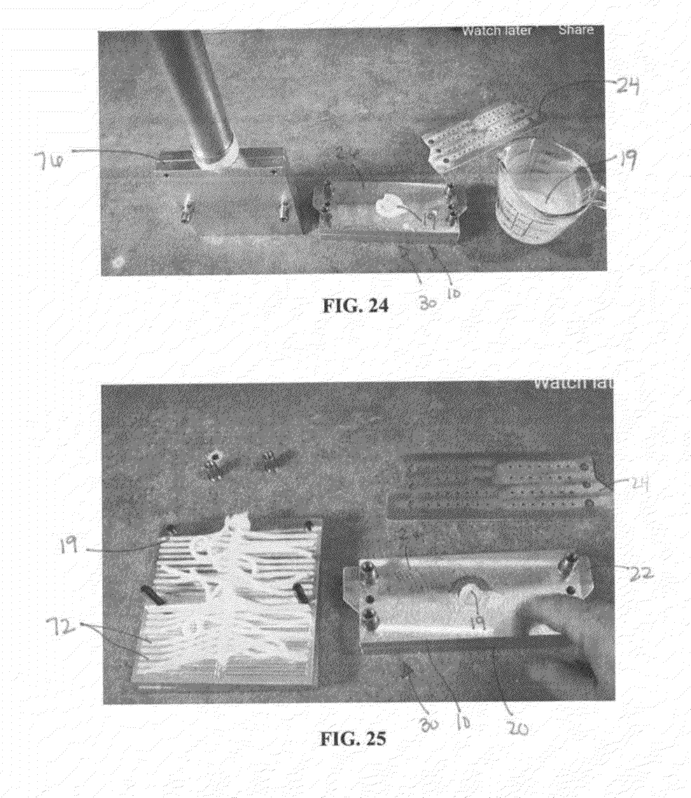

Referring specifically to FIGS. 7 and 12, the first stem plate 22 and the second stem plate 24 define at least one stem cavity 44, extending therethrough. In one nonlimiting example, the first stem plate 22 and the second stem plate 24 each define a plurality of stem cavities 44. It should be appreciated that the first stem plate 22 and the second stem plate 24 may have any desired number of stem cavities 44, as the number of stem cavities 44 on each of the first stem cavities 44 is equivalent to the number of eyeballs 12 to be formed by the injection mold 10. When the injection mold 10 is arranged in the first configuration 28, the plurality of stem cavities 44 of the first stem plate 22 are in axial alignment with the corresponding stem cavities 44 of the second stem plate 24 to define a plurality of stem channels 46. The plurality of stem channels 46 are in fluid communication with pupil channels 40. In one nonlimiting embodiment, the stem channels 46 may be cylindrically shaped, to produce a pupil 16 having a circular shape, as will be explained in more detail below. It should be appreciated that the stem channels 46 may have other shapes, including, but not limited do, an oval shaped cylinder, a star shaped prism, a hexagonal shaped prism, a cuboid, and the like.

Referring between FIGS. 7-9 and 12-14, the second mold plate 26 includes a first side 48 and a second side 50, opposite the first side 48. The mold also includes a second injection port 52 extending between the first side 48 and the second side 50. When the injection mold 10 is arranged in the first configuration 28, the second mold plate 26 is arranged such that the first side 48 is in facing relationship to the second stem plate 24, as shown in FIGS. 7-9. Likewise, when the injection mold 10 is arranged in the second configuration 30, since the second stem plate 24 is removed, the second mold plate 26 is arranged such that the second side 50 is in facing relationship with the first stem plate 22, as shown in FIGS. 12-14.

The first side 48 of the second mold plate 26 is shown in FIG. 10. The first side 48 of the second mold plate 26 presents a generally planar surface, and defines the second injection port 52. With reference to FIGS. 7-9, when the injection mold 10 is arranged in the first configuration 28, the first surface is in facing relationship with the second stem plate 24, such that the plurality of stem cavities 44 of the second stem plate 24 are blocked by the surface of the first side 48 of the second mold plate 26. As such, in the first configuration 28, the stem channels 46 are in fluid communication with the first injection port 42 and are not in fluid communication with the second injection port 52, as will be explained in more detail below.

The second side 50 of the second mold plate 26 is shown in FIGS. 1 and 16. The second side 50 defines a plurality of iris cavities 54 and a plurality of iris channels 56. The plurality of iris channels 56 are provide fluid communication between the second injection port 52 and each of the plurality of iris cavities 54. Each iris cavity 54 may present a circular shape, i.e., a cylindrical shape, that surrounds the pupil 16, as will be explained in more detail below. It should be appreciated that each iris cavity 54 may present any other desired shape, including, but not limited to, a semispherical shape, triangular shaped, cone shaped, hexagonal shaped, tetrahedron shaped, pentagrammic shaped, hexagonal shaped, cuboidal shape, cube shaped, and the like. With reference to FIGS. 12-14, when the injection mold 10 is arranged in the second configuration 30, and the second stem plate 24 is removed, the second side 50 of the second mold plate 26 are in facing relationship with the first stem plate 22. As such, each of the plurality of iris cavities 54 are in alignment with a corresponding one of the plurality of stem channels 46.

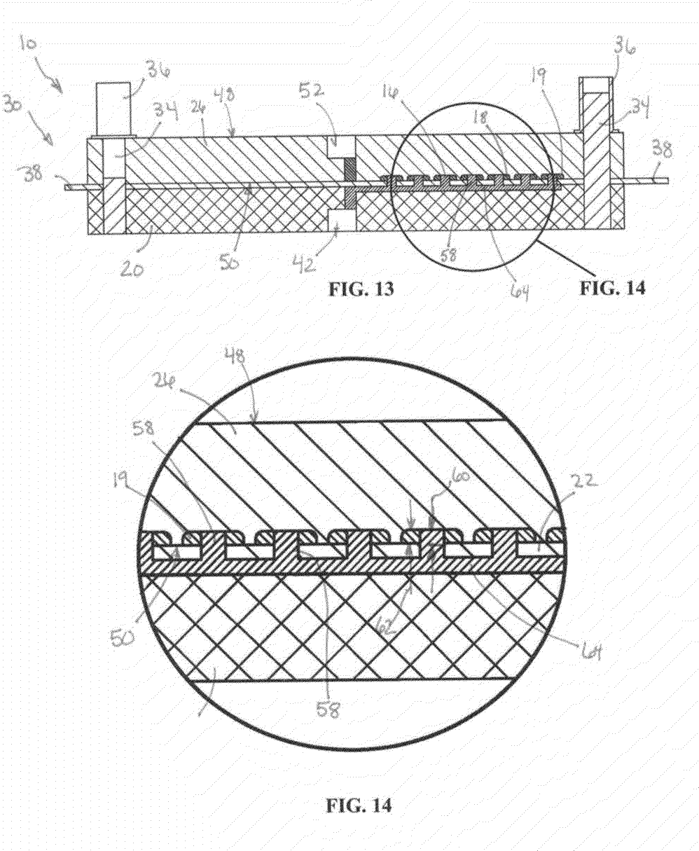

The eyeballs 12 are formed by first forming the pupils 16, when the injection mold 10 is in the first configuration 28, shown in FIGS. 5-9, and 16. The first flowable material 17 may be a thermoplastic material that is heated and injected under pressure to the first injection port 42, where the first flowable material 17 flows through the stem cavities 44 and into each of the stem channels 46 to form a plurality of pupils 18.

Once the first flowable material 17 has cooled and cured, i.e., a soft plastic and the like, the injection mold 10 is transformed from the first configuration 28 to the second configuration 30. The second stem plate 24 is removed, while leaving the first stem plate 22 in place. The second mold plate 26 is flipped over, such that the second side 50 is in facing relationship to the first stem plate 22. With reference to FIGS. 12-14, when the injection mold 10 is arranged in the second configuration 30, the stem channels 46 are aligned with the respective iris cavities 54, such that the pupils 18 are positioned relative to the iris cavities 54, prior to injection of the second flowable material 19. More specifically, after the second stem plate 24 is removed, a portion 58 of each pupil 18 extends beyond the first stem plate 22. Therefore, when the second mold plate 26 is arranged in the second configuration 30, the portion 58 of each pupil 18 extends into the respective iris cavity 54. The amount each pupil 18 extends into the respective iris cavity 54 is determined as a function of a thickness 60 of the second stem plate 24 and a depth 62 of the corresponding iris cavity 54. Additionally, each pupil 18 is sized to be smaller than the corresponding iris cavity 54, in order to allow the portion 58 of the pupil 18 to extend at least partially into the iris cavity 54. This allows the portion 58 of the pupil 18 to be partially encapsulated by the second flowable material 19, as explain in more detail below.

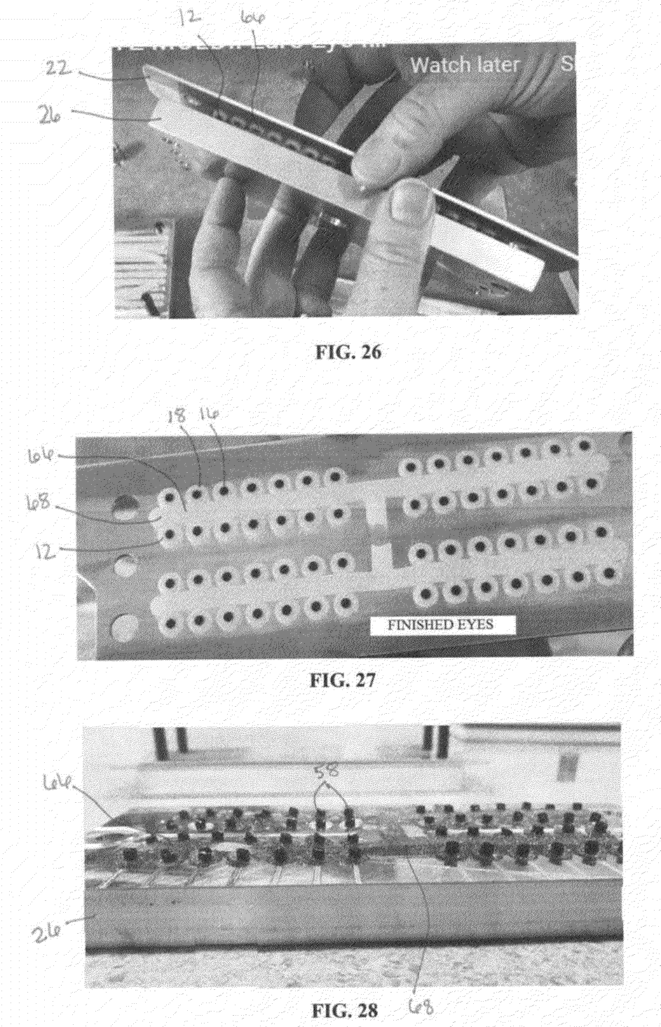

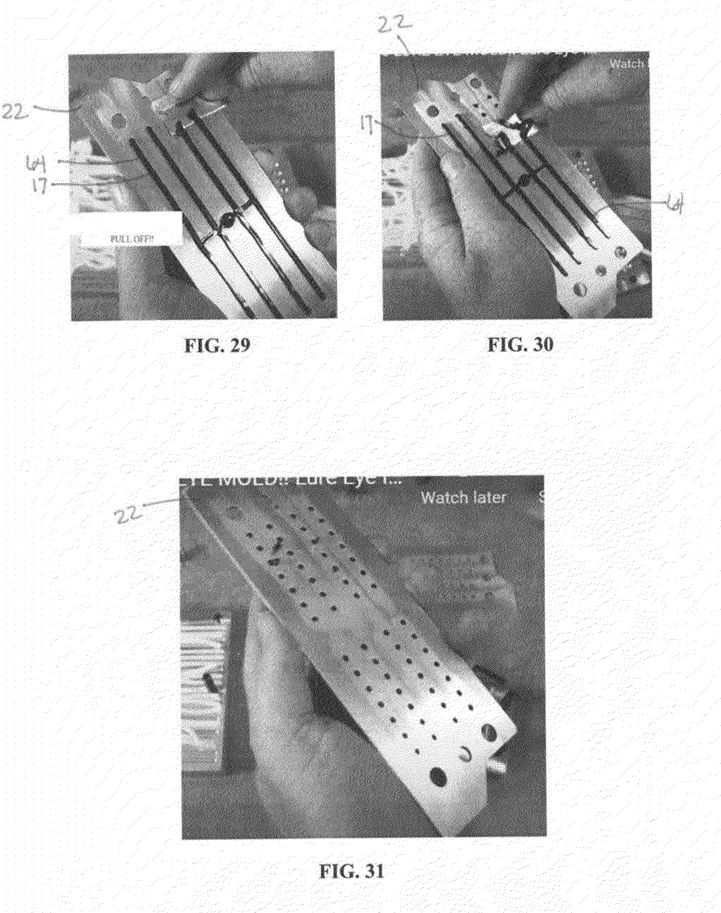

The second flowable material 19 is heated and injected under pressure to the second port, where the second flowable material 19 flows through the iris channels 56 and into the iris cavities 54, where the second flowable material 19 surrounds, or otherwise encapsulates the portion 58 of the iris 18 extending into each iris cavity 54. With reference to FIGS. 13 and 14, the cured material remains in place while injecting the second flowable material 19. Therefore, the second flowable material 19 is prevented from flowing through the stem cavities 44 of the first stem plate 22.

Once the second flowable material 19 is cooled and cured, the first mold plate 20 and the second mold plate 26 are separated from the first stem plate 22. A pupil runner 64 is scraped or otherwise removed from a side of the first stem plate 22, opposite an iris 18 side of the first stem plate 22. Once the pupil runner 64 is removed, a string of interconnected eyeballs 66 are removed from the first stem plate 22. The eyeballs 12 are initially interconnected via cured material, i.e., an iris runner 68, from the flow of the second flowable material 19 through iris channels 56. Each eyeball 12 may be separated from the iris runner 68. Each eyeball 12 includes a stem 70 protruding from pupil 18. These stems 70 correspond to the thickness 60 of the first stem plate 22. The eyeball 12 may be used to form a lure 14 via a subsequent injection molding process. In doing so, it may be preferable to keep the portion of the stem intact, as the stem 70 may provide additional surface area to promote bonding of the eyeball 12 to the lure 14. However, if the stem 70 is not desirable, the stem 70 may be cut off from the eyeball 12 or otherwise removed.

Referring now to FIG. 4, the eyeballs 12 may be formed such that a color of the pupil 18 and/or iris 18 is the same as at least a portion 58 of the lure 14, e.g., a bloodline 72, a fish 74, and the like. In a nonlimiting embodiment, the iris 18 is formed with the same second flowable material 19 as the bloodline 72, in a second injection mold 76. Then, a plurality of eyeballs 12 and bloodlines 72 are placed into a third injection mold 78, where a plurality of lures 14 are formed.

Several embodiments have been discussed in the foregoing description. However, the embodiments discussed herein are not intended to be exhaustive or limit the disclosure to any particular form. The terminology which has been used is intended to be in the nature of words of description rather than of limitation. Many modifications and variations are possible in light of the above teachings and the disclosure may be practiced otherwise than as specifically described.

1. An injection mold configured to form an eyeball for a fishing lure, the injection mold comprising:
a first mold plate defining a first injection port;
a first stem plate defining a stem cavity;
a second stem plate defining a stem cavity;
a second mold plate including:
a first side and a second side, opposite the first side; and
a second injection port extending between the first side and the second side;
wherein the second side defines an iris cavity in fluid communication with the second injection port;
wherein the injection mold is configured to be assembled in a first configuration, such that the first stem plate is sandwiched between the first mold plate and the second stem plate and the second stem plate is sandwiched between the first stem plate and the second mold plate;
wherein the injection mold is configured to be assembled in a second configuration, such that the first stem plate is sandwiched between the first mold plate and the second mold plate;
wherein a stem cavity of first stem plate is aligned with a stem cavity of the second stem plate to define a stem channel in fluid communication with the first injection port when the injection mold is assembled in the first configuration, such that the stem channel is configured to receive a first flowable material from the first injection port to form a pupil stem of an eyeball; and
wherein the stem cavity of the first stem plate is in fluid communication with the iris cavity and the second injection port when the injection mold is assembled in the second configuration, such that the iris cavity is configured to receive a second flowable material from the second injection port to form an iris of the eyeball.

2. A method of forming a plurality of eyeballs using an injection mold, the method comprising:
arranging the injection mold in a first configuration, such that a first stem plate and a second stem plate are sandwiched between a first mold plate and a second mold plate;
injecting a first flowable material into the injection mold through a first injection port defined in the first mold plate to form a plurality of retinas for each of the plurality of eyeballs;
removing the second mold plate from the injection mold;
removing the second stem plate from the first stem plate, such that a portion of each of the plurality of retinas is exposed to extend from the first stem plate;
arranging the injection mold in second configuration, such that a second side of the second mold plate is in facing relationship to the first stem plate, and the portion of each of the plurality of retinas extends into a respective iris cavity defined in the second side of the second mold plate; and
injecting a second flowable material into the injection mold through a second injection port defined in the second mold plate to form an iris that surrounds the portion of each of the plurality of retinas extending into the respective iris cavity.
